(19) United States
(12) Patent Application Publication
(10) Pub. No.: US 2026/0312194 A1
(43) Pub. Date: Oct. 8, 2026

(54) TOP COVER ASSEMBLY AND BATTERY

(71) Applicant: EVE POWER CO., LTD., Jingmen (CN)

(72) Inventors: Pengxiang ZHU, Jingmen (CN); Qiuping LI, Jingmen (CN); Yu ZHOU, Jingmen (CN); Fei SUN, Jingmen (CN)

(21) Appl. No.: 19/634,132

(22) Filed: Mar. 31, 2026

(30) Foreign Application Priority Data
Apr. 2, 2025 (CN) 202520617518.3

(51) Int. Cl. H01M 50/188; H01M 50/15

(52) U.S. Cl. CPC H01M 50/188; H01M 50/15

(57) ABSTRACT

The present disclosure discloses a top cover assembly and a battery. The top cover assembly includes a cover plate and a fitted assembly. The cover plate has a through hole extending through a first side and a second side, the first side and the second side being opposite sides of the cover plate. The fitted assembly includes a pole, a first insulation member, and a metal sleeve. The pole passes through the through hole and protrudes from the first side. The first insulation member is disposed around the pole and located at the first side of the cover plate. The metal sleeve is disposed around the pole and at least partially located at the first side of the cover plate. The metal sleeve is connected to the first insulation member. The first insulation member is disposed between the metal sleeve and the pole.

### CROSS-REFERENCE TO RELATED APPLICATION

This application is based on and claims priority to Chinese Patent Application No. 202520617518.3, filed on Apr. 2, 2025 and entitled “TOP COVER ASSEMBLY AND BATTERY”, the entire contents of which are incorporated herein by reference.

### FIELD

The present disclosure relates to the technical field of batteries, and in particular, to a top cover assembly and a battery.

### BACKGROUND

A top cover assembly is a structure mounted at an end of a square housing for sealing the housing. In an existing battery top cover, during assembly of the entire top cover assembly, as shown in FIG. 1, the top cover assembly includes a cover plate 1’, a pole 5’, a pressure plate 6’, a base plate 4’ disposed at a bottom of the pole 5’, a first insulation member 2’ disposed between the pressure plate 6’ and the cover plate 1’, and a second insulation member 3’ disposed between the base plate 4’ and the cover plate 1’. When the pole 5’ is used as a negative pole, the base plate 4’ is a copper base plate 4’, the pole 5’ is an aluminum pole 5’, and the pressure plate 6’ is also an aluminum pressure plate 6’.

During assembly, the copper base plate 4’ and the aluminum pole 5’ are mostly joined together by copper‑aluminum friction welding to form a friction weld seam B’. Then, the aluminum pole 5’ and the aluminum pressure plate 6’ are connected by a riveting process, followed by laser welding at the riveted connection to form a weld seam A’, so that the aluminum pole 5’ and the aluminum pressure plate 6’ are fused together. Thus, the entire top cover assembly requires multiple welding operations, resulting in a complicated assembly method and high production costs for the top cover assembly.

### SUMMARY

In order to solve at least one problem existing in the related art, according to an aspect of the present disclosure, a top cover assembly is provided. The top cover assembly includes: a cover plate having a through hole extending through a first side and a second side, the first side and the second side being opposite sides of the cover plate; and a fitted assembly. The fitted assembly includes: a pole passing through the through hole and protruding from the first side; a first insulation member disposed around the pole and located at the first side of the cover plate; and a metal sleeve disposed around the pole and at least partially located at the first side of the cover plate. The metal sleeve is connected to the first insulation member, and the first insulation member is disposed between the metal sleeve and the pole.

According to another aspect of the present disclosure, a top cover assembly is provided. The top cover assembly includes: a pole including a first metal layer and a second metal layer that are arranged sequentially in a first direction; a sealing ring arranged around the second metal layer; a metal sleeve arranged around the sealing ring; a first insulation member sandwiched between the second metal layer and the metal sleeve; and a cover plate disposed at an outer periphery of the metal sleeve and connected to the metal sleeve. The first metal layer, the second metal layer, the sealing ring, the metal sleeve, and the first insulation member are press-fitted together.

In some embodiments, a thickness H1 of the first metal layer in the first direction ranges from 2.0 mm to 2.5 mm.

In some embodiments, the second metal layer includes a first fitting segment and a connection segment that are arranged to form an angle. The first fitting segment is fitted with the first metal layer, and the connection segment is configured to be connected to an adapter sheet.

In some embodiments, in the first direction, a thickness of the first fitting segment is smaller than a thickness of the connection segment.

In some embodiments, a thickness H2 of the first fitting segment ranges from 0.5 mm to 1.0 mm, and a thickness H3 of the connection segment ranges from 2.0 mm to 5.0 mm.

In some embodiments, the first metal layer has a first engagement groove at a side of the first metal layer facing the second metal layer, the second metal layer is provided with a first protrusion at a side of the second metal layer facing the first metal layer, and the first protrusion is embedded in the first engagement groove.

In some embodiments, in a direction perpendicular to the first direction, a width of the first engagement groove is 1/10 to 1/6 of a width of the first metal layer.

In some embodiments, the first protrusion is located at a joint between the first fitting segment and the connection segment.

In some embodiments, the connection segment has a first groove formed at a side of the connection segment facing away from the first metal layer, and a top wall of the first groove is configured to be connected to the adapter sheet.

In some embodiments, the second metal layer has a third engagement groove formed at a side of the second metal layer facing the sealing ring. The third engagement groove is configured to be fitted with the sealing ring. A depth H4 of the third engagement groove in the first direction ranges from 0.2 mm to 0.8 mm.

In some embodiments, a compression amount of the sealing ring ranges from 15% to 45%.

In some embodiments, a thickness H5 of the metal sleeve in the first direction ranges from 0.5 mm to 1.0 mm.

In some embodiments, the metal sleeve includes a first segment and a second segment that are arranged to form an angle. The first segment is sandwiched between the cover plate and the first insulation member. The second segment is sandwiched between the cover plate and the sealing ring. A connection region between the first segment and the second segment is fitted with the sealing ring. The first segment protrudes beyond the first insulation member in a radial direction of the first metal layer.

According to yet another aspect of the present disclosure, a battery is provided. The battery includes the top cover assembly described above.

In summary, the top cover assembly and the battery provided by the present disclosure have the following technical effects.

The first metal layer, the second metal layer, the sealing ring, the metal sleeve, and the first insulation member are press-fitted together. The first insulation member is also sandwiched between the second metal layer and the metal sleeve. Multiple components may be directly formed as a single unit by applying an external force. Finally, the cover plate and the metal sleeve only need to be connected, for example, by welding. Thus, the entire top cover assembly employs a straightforward forming method and simple procedure, which can reduce production costs. Moreover, compared with the related art where the first metal layer and the second metal layer need to be welded together, and the second metal layer is further welded to a pole of a battery cell through the adapter sheet, in the present disclosure, only the second metal layer needs to be welded to the adapter sheet, which reduces welding positions, lowers internal resistance of the connection between the pole and the battery cell, and improves service performance of the battery.

### BRIEF DESCRIPTION OF THE DRAWINGS

FIG. 1 is a schematic structural view of a top cover assembly in the related art.

FIG. 2 is a schematic structural view of a first metal layer, a second metal layer, a sealing ring, a metal sleeve, and a first insulation member before press-fitting according to an embodiment of the present disclosure.

FIG. 3 is an enlarged schematic view of a portion I in FIG. 2.

FIG. 4 is a schematic structural view of a first metal layer, a second metal layer, a sealing ring, a metal sleeve, and a first insulation member after press-fitting according to an embodiment of the present disclosure.

FIG. 5 is a schematic structural view of a top cover assembly according to an embodiment of the present disclosure.

Reference numerals: 100-top cover assembly, 10-pole, 11-first metal layer, 111-first engagement groove, 112-second protrusion, 12-second metal layer, 121-first protrusion, 122-second engagement groove, 123-first groove, 124-first fitting segment, 125-connection segment, 126-third engagement groove, 20-sealing ring, 21-second fitting segment, 22-blocking segment, 30-metal sleeve, 31-first segment, 32-second segment, 40-first insulation member, 50-cover plate, 51-second groove, 60-second insulation member.

### DETAILED DESCRIPTION

For better understanding and implementation, the technical solutions in the embodiments of the present disclosure will be clearly and completely described below with reference to the accompanying drawings in the embodiments of the present disclosure.

In the description of the present disclosure, it should be noted that, terms such as “upper”, “lower”, “front”, “back”, “left”, “right”, “vertical”, “horizontal”, “top”, “bottom”, “in”, “out”, and the like are based on orientations or positional relationships shown in the drawings, and facilitate the description of the present disclosure and simplify the description merely, rather than indicating or implying that the associated apparatus or element must have specific orientations and are constructed and operated in the specific orientations, and thus should not be construed to limit the present disclosure.

Unless otherwise defined, all technical and scientific terms used in the present disclosure have the same meaning as commonly understood by those skilled in the art of the present disclosure. Terms in the specification of the present disclosure herein are only used for purpose of describing specific embodiments rather than intended to limit the present disclosure.

The present disclosure will be described in further detail below with reference to the accompanying drawings.

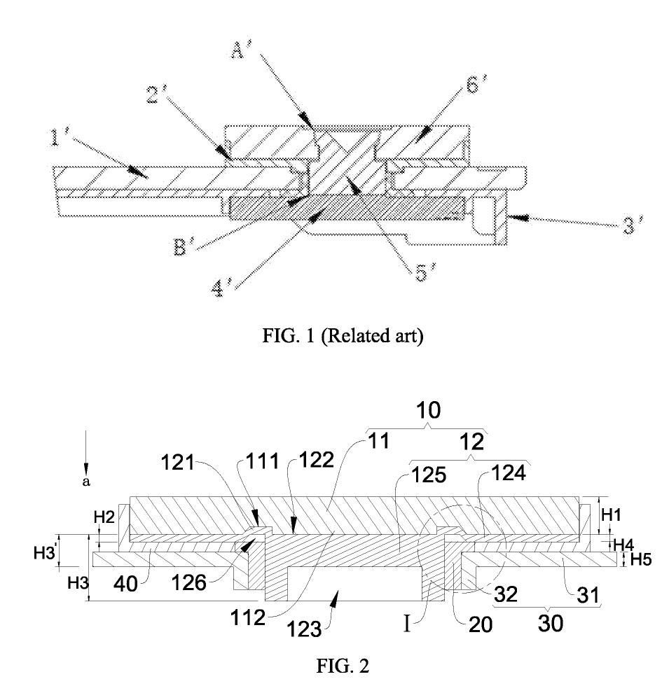

Referring to FIGS. 2 to 5, a top cover assembly 100 provided according to an embodiment of the present disclosure includes a pole 10, a sealing ring 20, a metal sleeve 30, a first insulation member 40, and a cover plate 50.

The pole 10 includes a first metal layer 11 and a second metal layer 12 stacked in a first direction a. The sealing ring 20 is arranged around the second metal layer 12. The metal sleeve 30 is arranged around the sealing ring 20. The first insulation member 40 is sandwiched between the second metal layer 12 and the metal sleeve 30. The cover plate 50 is disposed outside the metal sleeve 30 and connected to the metal sleeve 30. The first metal layer 11, the second metal layer 12, the sealing ring 20, the metal sleeve 30, and the first insulation member 40 are press-fitted together.

The above top cover assembly 100, the first metal layer 11, the second metal layer 12, the sealing ring 20, the metal sleeve 30, and the first insulation member 40 are press-fitted together. The first insulation member 40 is also sandwiched between the second metal layer 12 and the metal sleeve 30. The five components may be directly formed as a single unit by applying an external force. Finally, the cover plate 50 and the metal sleeve 30 only need to be connected, for example, by welding. Thus, the entire top cover assembly 100 employs a straightforward forming method and simple procedure, which can reduce production costs. Moreover, compared with the related art where the first metal layer 11 and the second metal layer 12 need to be welded together, and the second metal layer 12 is further welded to a pole 10 of a battery cell through an adapter sheet, in this embodiment, only the second metal layer 12 needs to be welded to the adapter sheet, which reduces welding positions, lowers internal resistance of the connection between the pole 10 and the battery cell, and improves service performance of the battery.

The pole 10 in the embodiment includes two metal layers. When the pole 10 is a negative pole, the first metal layer 11 is an aluminum layer, and the second metal layer 12 is a copper layer. In the related art, the aluminum layer and the copper layer are usually connected by welding, resulting in a complicated process and high resistance after the welding connection.

It can be understood that, in the above structure, the first insulation member 40 provides insulation and protection between the pole 10 and the cover plate 50, separating the cover plate 50 from the pole 10 to avoid a short circuit phenomenon, ensuring stable electrical performance and safe use of the battery. The sealing ring 20 is used to ensure sealing performance of the battery after the top cover assembly 100 is applied in a square battery, which prevents leakage of an electrolyte inside the battery and prevents impurities such as external air and moisture from entering the battery, ensuring performance and safety of the battery and prolonging a service life of the battery. Since the first insulation member 40 and the sealing ring 20 are made of plastic materials, they may be pressed incompactly when being press-fitted with the first metal layer 11 and the second metal layer 12 respectively due to the certain deformability of plastic materials. By providing the metal sleeve 30 made of metal, a pressing force can be applied to the sealing ring 20 and the first insulation member 40, so that the five components can be fixed by pressing.

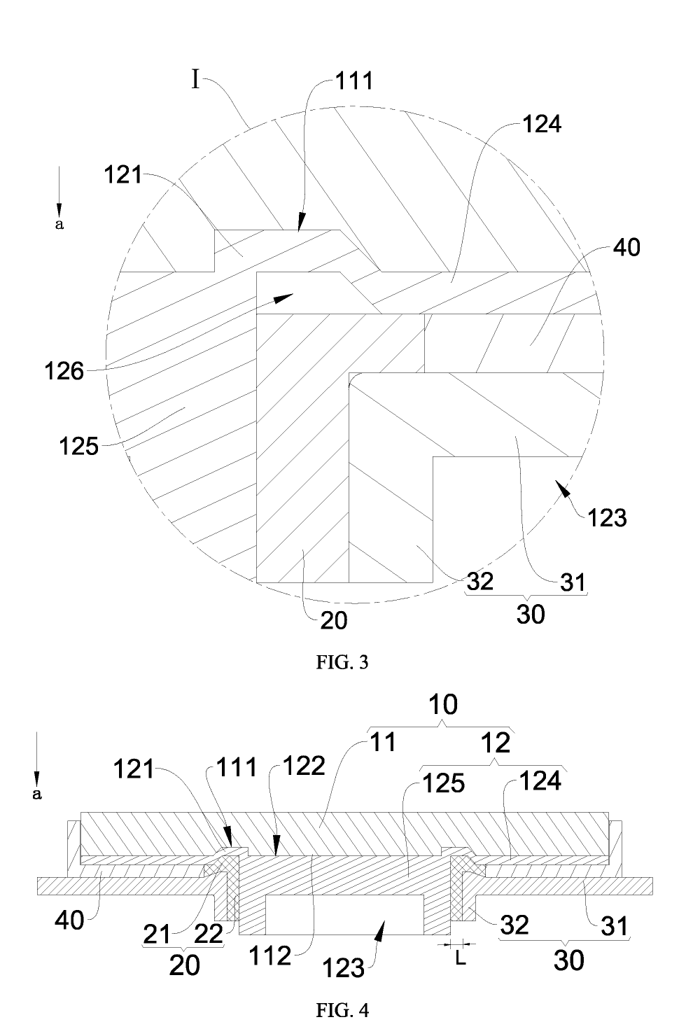

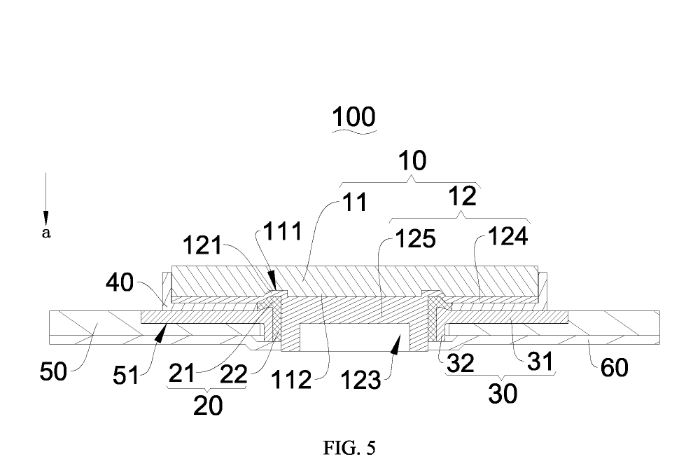

In this embodiment, the structures of the first metal layer 11, the second metal layer 12, the sealing ring 20, the metal sleeve 30, and the first insulation member 40 before press-fitting are shown in FIGS. 2 and 3. The structure after press-fitting is shown in FIG. 4. The structure after a welding connection of the above press-fitted components with the cover plate 50 is shown in FIG. 5.

Since the cover plate 50 is made of aluminum, the metal sleeve 30 in the embodiment is preferably made of aluminum. Both the cover plate 50 and the metal sleeve 30 have the same melting temperature, making it convenient to weld them together as a whole.

The first metal layer 11 needs to be welded to an aluminum busbar and will melt during the welding, so a welding strength needs to be ensured. Therefore, a thickness H1 of the first metal layer 11 in the first direction a ranges from 2.0 mm to 2.5 mm. In this way, the thickness of the first metal layer 11 is not so large as to cause an excessively high overall height of the top cover assembly 100, and not so small as to make welding with the aluminum busbar difficult.

In some embodiments, the thickness H1 of the first metal layer 11 in the first direction a may be 2.0 mm, 2.1 mm, 2.2 mm, 2.3 mm, 2.4 mm, 2.5 mm, or the like, which is not limited herein.

Referring to FIGS. 2 to 5, in an embodiment of the present disclosure, the second metal layer 12 includes a first fitting segment 124 and a connection segment 125 that are arranged to form an angle, specifically, arranged perpendicularly to each other. The first fitting segment 124 is fitted with the first metal layer 11, and the connection segment 125 is configured to be connected to an adapter sheet. An outer diameter of the first fitting segment 124 is greater than an outer diameter of the connection segment 125. In this way, the first fitting segment 124 with a larger coverage area can be connected to the first metal layer 11, increasing a connection area between the first metal layer 11 and the second metal layer 12, enhancing a support strength for the first metal layer 11, ensuring the connection area between the first metal layer 11 and the second metal layer 12, and avoiding fracture at the joint between the first fitting segment 124 and the connection segment 125.

Further, in a radial direction of the first metal layer 11, an outer edge of the first fitting segment 124 coincides with an outer edge of the first metal layer 11. In this way, a sufficient connection area is ensured between the first fitting segment 124 and the first metal layer 11. Meanwhile, when the first insulation member 40 is provided for connection, the first insulation member 40 can be in contact with the outer edges of the first metal layer 11 and the first fitting segment 124, ensuring sealing performance between the first insulation member 40 and the first metal layer 11 and between the first insulation member 40 and the first fitting segment 124.

When the first fitting segment 124 and the connection segment 125 are arranged, in the first direction a, a thickness of the first fitting segment 124 is smaller than a thickness of the connection segment 125. Since the first fitting segment 124 is configured to be fitted with the first metal layer 11, and the first metal layer 11, the first insulation member 40, the metal sleeve 30, and the cover plate 50 need to be arranged sequentially in the first direction a, a thickness of the entire top cover assembly 100 can be set within a predetermined range by providing the first fitting segment 124 with a smaller thickness, avoiding an excessively thick top cover assembly 100. Since the connection segment 125 needs to be welded to the adapter sheet and will melt during the welding, the connection segment 125 with a larger thickness is provided to facilitate its welding with the adapter sheet, ensure its connection strength with the adapter sheet, and avoid a risk of fracture during the welding.

Specifically, a thickness H2 of the first fitting segment 124 ranges from 0.5 mm to 1.0 mm, and a thickness H3 of the connection segment 125 ranges from 2.0 mm to 5.0 mm. Thus, the first fitting segment 124 has a certain support strength to avoid fracture without making the entire top cover assembly 100 excessively thick. The connection segment 125 has a certain support thickness to facilitate its welding with the adapter sheet while ensuring a support strength of the entire pole 10. The thickness H2 of the first fitting segment 124 may be set to 0.5 mm, 0.6 mm, 0.7 mm, 0.8 mm, 0.9 mm, 1.0 mm, or the like, which is not limited herein. The thickness H3 of the connection segment 125 may be set to 2.0 mm, 2.1 mm, 2.2 mm, 2.3 mm, 2.4 mm, 2.5 mm, or the like, which is not limited herein.

Specifically, referring to FIG. 3, when the first fitting segment 124 is fitted with the first metal layer 11, the first metal layer 11 has a first engagement groove 111 at a side of the first metal layer 11 facing the second metal layer 12, the second metal layer 12 is provided with a first protrusion 121 at a side of the second metal layer 12 facing the first metal layer 11, and the first protrusion 121 is embedded in the first engagement groove 111. The fitting between the engagement groove and the protrusion ensures fitting stability and avoids relative separation. The first engagement groove 111 has a right trapezoidal cross-section to form an inclined surface, which provides a guiding function during pressing. In other embodiments, the cross-section of the first engagement groove 111 may alternatively be configured as a square shape, a triangular shape, or the like.

In a direction perpendicular to the first direction a, a width of the first engagement groove 111 may be 1/10 to 1/6 of a width of the first metal layer 11. Thus, a certain fitting area is formed between the first metal layer 11 and the second metal layer 12. Moreover, the fitting area is not too large to increase pressing difficulty between the first metal layer 11 and the second metal layer 12, nor too small to affect a connection strength between the two layers. For example, a width of the first engagement groove 111 in the radial direction of the first metal layer 11 may be 1/10, 1/8, 1/6, or the like of a radius of the first metal layer 11, which is not limited herein.

Further, in order to ensure the fitting strength, the first protrusion 121 is located at the joint between the first fitting segment 124 and the connection segment 125. When the first protrusion 121 is located at the joint between the first fitting segment 124 and the connection segment 125, for example, as shown in FIGS. 2 to 5, it is equivalent to that a second engagement groove 122 is formed in a central region of the second metal layer 12 facing the first metal layer 11, a second protrusion 112 is provided at the side of the first metal layer 11 facing the second metal layer 12, and the second protrusion 112 is engaged in the second engagement groove 122. The connection between the first metal layer 11 and the second metal layer 12 is implemented in the central region, ensuring the connection strength between the first metal layer 11 and the second metal layer 12.

In addition, a plurality of first engagement grooves 111 may be formed in the radial direction of the first metal layer 11, and a plurality of first protrusions 121 may be provided on the second metal layer 12. One first protrusion 121 is fitted with one corresponding first engagement groove 111. The connection between the plurality of first engagement grooves 111 and the plurality of first protrusions 121 ensures a connection area between the first metal layer 11 and the second metal layer 12, thereby ensuring a connection strength between them.

Referring to FIGS. 2 to 5, in an embodiment of the present disclosure, since the second metal layer 12 is usually made of copper that is relatively expensive, in order to save cost, the connection segment 125 has a first groove 123 at a side of the connection segment 125 facing away from the first metal layer 11. A top wall of the first groove 123 is configured to be connected to the adapter sheet, i.e., the second metal layer 12 is hollow, and no copper material is present in the hollow position, achieving an effect of reducing the cost. In another embodiment, the second metal layer 12 may also be configured as a solid structure, facilitating stamping with the first metal layer 11 during molding, with a flat lower surface providing a large contact area with a stamping mechanism during stamping.

Further, referring to FIG. 1, corresponding to the connection segment 125 of the hollow second metal layer 12, a thickness H3’ of a region where the connection segment 125 is connected to the adapter sheet ranges from 1.0 mm to 1.3 mm. Since this region needs to be welded to the adapter sheet, the setting of the thickness H3’ of the region ensures a support strength and connection strength, avoiding a risk of fracture caused by high temperature during welding

Referring to FIG. 3, in an embodiment of the present disclosure, in order to ensure a fitting strength between the second metal layer 12 and the sealing ring 20, the second metal layer 12 has a third engagement groove 126 at a side of the second metal layer 12 facing the sealing ring 20. The third engagement groove 126 is configured to be fitted with the sealing ring 20. A depth H4 of the third engagement groove 126 in the first direction a ranges from 0.2 mm to 0.8 mm. In this way, by providing the third engagement groove 126, the sealing ring 20 is embedded in the second metal layer 12, ensuring connection tightness between the second metal layer 12 and the sealing ring 20. Meanwhile, setting the depth H4 of the third engagement groove 126 to range from 0.2 mm to 0.8 mm enables the second metal layer 12 to have a certain connection area with the sealing ring 20 to clamp the sealing ring 20 in the second metal layer 12. This value setting ensures that the depth of the third engagement groove 126 is not too shallow to result in a too low connection strength between the second metal layer 12 and the sealing ring 20, and not too deep to cause the sealing ring 20 to fail to fill the third engagement groove 126, resulting in the existence of air in the third engagement groove 126 and poor sealing during later use.

The depth H4 of the third engagement groove 126 may be set to 0.2 mm, 0.3 mm, 0.4 mm, 0.5 mm, 0.6 mm, 0.7 mm, 0.8 mm, or the like, which is not limited herein.

It can be understood that, referring to FIGS. 4 and 5, the sealing ring 20 in this embodiment includes a second fitting segment 21 and a blocking segment 22. The second fitting segment 21 is embedded in the third engagement groove 126 of the second metal layer 12, and the blocking segment 22 is blocked between the second metal layer 12 and the metal sleeve 30, to electrically insulate between the metal sleeve 30 and the second metal layer 12. A thickness of the second fitting segment 21 is the same as a thickness of the first insulation member 40. Referring to FIG. 4, a thickness L of the blocking segment 22 in the radial direction of the first metal layer 11 ranges from 1.0 mm to 1.6 mm, so that the blocking segment 22 has a certain blocking thickness to possess a certain structural strength, realizing electrical insulation between the second metal layer 12 and the metal sleeve 30 and between the second metal layer 12 and the cover plate 50.

The thickness L of the blocking segment 22 in the radial direction of the first metal layer 11 may be 1.0 mm, 1.1 mm, 1.2 mm, 1.3 mm, 1.4 mm, 1.5 mm, 1.6 mm, or the like, which is not limited herein.

In addition, after pressing assembly of the first metal layer 11, the second metal layer 12, the sealing ring 20, the metal sleeve 30, and the first insulation member 40 is completed, a compression amount of the sealing ring 20 ranges from 15% to 45%. By setting this compression amount, a sealing effect can be achieved, preventing the sealing ring 20 from becoming easily disengaged due to an excessively small compression amount or aging due to an excessively large compression amount.

In some embodiments, the compression amount of the sealing ring 20 may be set to 15%, 20%, 25%, 30%, 35%, 40%, 45%, or the like, which is not limited herein.

Referring to FIG. 1, when the metal sleeve 30 in this embodiment is arranged, in order to ensure a pressing strength among the first metal layer 11, the second metal layer 12, the sealing ring 20, and the first insulation member 40, a thickness H5 of the metal sleeve 30 ranges from 0.5 mm to 1.0 mm. Through this arrangement, the metal sleeve 30 has a certain structural strength, and can provide a pre-tightening force for pressing among the first metal layer 11, the second metal layer 12, the sealing ring 20, and the first insulation member 40 during pressing, and the metal sleeve 30 has a certain thickness to facilitate the subsequent welding connection with the cover plate 50.

The thickness H5 of the metal sleeve 30 may be set to 0.5 mm, 0.6 mm, 0.7 mm, 0.8 mm, 0.9 mm, 1.0 mm, or the like, which is not limited herein.

Specifically, when the metal sleeve 30 in the embodiment is arranged, the metal sleeve 30 includes a first segment 31 and a second segment 32 that are arranged to form an angle, specifically, arranged perpendicularly to each other. The first segment 31 is sandwiched between the cover plate 50 and the first insulation member 40. The second segment 32 is sandwiched between the cover plate 50 and the sealing ring 20. A connection region between the first segment 31 and the second segment 32 is fitted with the sealing ring 20. In the radial direction of the first metal layer 11, the first segment 31 protrudes beyond the first insulation member 40. In this way, the metal sleeve 30 and the sealing ring 20 are also fitted with each other, ensuring connection tightness between the metal sleeve 30 and the sealing ring 20. By making the first segment 31 protrude beyond the first insulation member 40, i.e., an edge of the first segment 31 is exposed relative to the first insulation member 40, welding of the first segment 31 and the cover plate 50 into a single unit can be facilitated.

Further, referring to FIG. 5, in order to ensure a connection strength between the cover plate 50 and the entire metal sleeve 30, the cover plate 50 has a second groove 51 facing the first segment 31, and the first segment 31 is disposed in the second groove 51. In this way, the second groove 51 formed on the cover plate 50 can position the arrangement position of the metal sleeve 30 and facilitate a welding connection between the cover plate 50 and the metal sleeve 30.

It can be understood that the first metal layer 11, the second metal layer 12, the sealing ring 20, the metal sleeve 30, and the first insulation member 40 are assembled into a single unit by press-fitting, and the metal sleeve 30 and the sealing ring 20 are tightly fitted. The assembly of the entire top cover assembly 100 can be completed only by welding the edge of the first segment 31 to the cover plate 50.

Further, the top cover assembly 100 may further include a second insulation member 60. The second insulation member 60 is disposed at a lower surface of the cover plate 50 in the first direction a, and abuts against end portions of the second segment 32 and the blocking segment 22 in the first direction a, to electrically insulate the cover plate 50 from the pole 10 and avoid a battery short circuit caused by direct contact between the pole 10 and a battery housing. Meanwhile, by providing the second insulation member 60, the second insulation member 60 forms multiple sealing surfaces with the cover plate 50 and the pole 10 respectively, preventing the electrolyte from seeping out from a gap between the pole 10 and the cover plate 50. During use of the battery, the second insulation member 60 can also absorb mechanical vibration and impact applied to the battery in a vehicle or device, reducing damage to an internal battery cell structure.

In the above top cover assembly 100, by press-fitting the first metal layer 11, the second metal layer 12, the sealing ring 20, the metal sleeve 30, and the first insulation member 40 together, mounting steps of the top cover assembly 100 are simplified, and the production cost is reduced. Meanwhile, only subsequent welding between the second metal layer 12 and the adapter sheet is needed, reducing internal resistance during battery conduction.

In another embodiment, the present disclosure further provides a battery, including a square housing, a battery cell, and the top cover assembly 100 described above. The battery cell is disposed in the square housing, the top cover assembly 100 covers an opening of the square housing, and the cover plate 50 is welded to the square housing, thereby sealing the square housing.

The technical means disclosed in the solution of the present disclosure are not limited to the technical means disclosed in the above embodiments, but also include technical solutions formed by any combination of the above technical features. It should be noted that, for those of ordinary skill in the art, various changes and modifications can be made to these embodiments without departing from the principles of the present disclosure. Further, these changes and modifications should be regarded as falling within the scope of the present disclosure.

What is claimed is:

1. A top cover assembly, comprising:
a cover plate having a through hole extending through a first side and a second side, the first side and the second side being opposite sides of the cover plate; and
a fitted assembly, wherein the fitted assembly comprises:
a pole passing through the through hole and protruding from the first side;
a first insulation member disposed around the pole and located at the first side of the cover plate; and
a metal sleeve disposed around the pole and at least partially located at the first side of the cover plate, wherein the metal sleeve is connected to the first insulation member, and wherein the first insulation member is disposed between the metal sleeve and the pole.

2. The top cover assembly according to claim 1, wherein the metal sleeve is connected to the cover plate, and wherein a thickness H5 of the metal sleeve ranges from 0.5 mm to 1.0 mm.

3. The top cover assembly according to claim 1, wherein the metal sleeve has a first segment and a second segment that are connected to each other and form an included angle, and wherein the cover plate has a second groove facing the first segment, the first segment being disposed in the second groove.

4. The top cover assembly according to claim 3, wherein a top surface of the first segment facing away from the cover plate is flush with a top surface of the cover plate, and wherein a peripheral side surface of the first segment is attached to an inner wall surface of the second groove.

5. The top cover assembly according to claim 1, wherein:
the pole comprises a first metal layer and a second metal layer that are arranged sequentially in a first direction;
the fitted assembly further comprises a sealing ring arranged around the second metal layer, the metal sleeve being arranged around the sealing ring;
the first insulation member is sandwiched between the second metal layer and the metal sleeve; and
the cover plate is disposed on an outer periphery of the metal sleeve,
wherein the first metal layer, the second metal layer, the sealing ring, the metal sleeve, and the first insulation member are press-fitted together.

6. The top cover assembly according to claim 5, wherein a thickness H1 of the first metal layer in the first direction ranges from 2.0 mm to 2.5 mm.

7. The top cover assembly according to claim 5, wherein the second metal layer comprises a first fitting segment and a connection segment that are arranged to form an angle, wherein the first fitting segment is fitted with the first metal layer, and wherein the connection segment is configured to be connected to an adapter sheet.

8. The top cover assembly according to claim 7, wherein in the first direction, a thickness H2 of the first fitting segment is smaller than a thickness H3 of the connection segment.

9. The top cover assembly according to claim 8, wherein the thickness H2 of the first fitting segment ranges from 0.5 mm to 1.0 mm, and wherein the thickness H3 of the connection segment ranges from 2.0 mm to 5.0 mm.

10. The top cover assembly according to claim 7, wherein the first metal layer has a first engagement groove at a side of the first metal layer facing the second metal layer, and wherein the second metal layer is provided with a first protrusion at a side of the second metal layer facing the first metal layer, the first protrusion being embedded in the first engagement groove.

11. The top cover assembly according to claim 10, wherein:
in a direction perpendicular to the first direction, a width of the first engagement groove is 1/10 to 1/6 of a width of the first metal layer; and/or
the first protrusion is located at a joint between the first fitting segment and the connection segment.

12. The top cover assembly according to claim 7, wherein the connection segment has a first groove at a side of the connection segment facing away from the first metal layer, wherein a top wall of the first groove is configured to be connected to the adapter sheet.

13. The top cover assembly according to claim 5, wherein the second metal layer has a third engagement groove at a side of the second metal layer facing the sealing ring, wherein the third engagement groove is configured to be fitted with the sealing ring.

14. The top cover assembly according to claim 13, wherein a depth H4 of the third engagement groove in the first direction ranges from 0.2 mm to 0.8 mm.

15. The top cover assembly according to claim 5, wherein:
a first segment of the metal sleeve is sandwiched between the cover plate and the first insulation member;
a second segment of the metal sleeve is sandwiched between the cover plate and the sealing ring;
a connection region between the first segment and the second segment is fitted with the sealing ring; and
an edge of the first segment in a direction perpendicular to the first direction protrudes beyond the first insulation member.

16. The top cover assembly according to claim 5, wherein a compression amount of the sealing ring ranges from 15% to 45%.

17. A battery, comprising the top cover assembly according to claim 1.
